(19) United States
(12) Patent Application Publication
(10) Pub. No.: US 2017/0218099 A1
(43) Pub. Date: Aug. 3, 2017

(54) POLYPHOSPHORUS POLYMER THAT IS THIOL-FUNCTIONALISED AT THE CHAIN ENDS AND PRODUCTION METHOD THEREOF

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH); CENTRE NATIONAL DE LA RECHERCHE SCIENTIFIQUE, Paris cedex 16 (FR); UNIVERSITÉ PAUL SABATIER, Toulouse cedex 9 (FR)

(72) Inventors: Charlotte Dire, Clermont-Ferrand (FR); Rachid Matmour, Clermont-Ferrand (FR); Issam Blidi, El Alia (TN); Olivier Coutelier, Auzeville-Tolosane (FR); Mathias Destarac, Toulouse (FR)

(21) Appl. No.: 15/118,009

(22) PCT Filed: Feb. 10, 2015
(86) PCT No.: PCT/EP2015/052701

§ 371 Date: Aug. 10, 2016

(30) Foreign Application Priority Data
Feb. 11, 2014 (FR) 1451036

(51) Int. Cl. C08F 30/02; C08C 19/24

(52) U.S. Cl. CPC C08F 30/02; C08C 19/24

(57) ABSTRACT

The invention relates to a novel polyphosphorus-based chain-end thiol-functionalized polymer, the polymer chain of which comprises units bearing at least one pendant phosphonate function and/or at least one pendant phosphonic function along the chain. This novel polymer is quite particularly suited to participating in a thiol-ene coupling reaction, which affords the possibility of grafting the polyphosphorus-based polymers onto diene polymers, for example.

This application is a 371 national phase entry of PCT/EP2015/052701, filed 10 Feb. 2015, which claims benefit of French Patent Application No. 1451036, filed 11 Feb. 2014, the entire contents of which are incorporated herein by reference for all purposes.

### BACKGROUND

1. Technical Field

The present invention relates to a method for synthesizing a polymer bearing pendant phosphonate and/or phosphonic functions along the chain, which is thiol-functionalized at the chain end. The present invention also relates to such a thiol-terminated polyphosphorus-based polymer.

2. Related Art

In order to modify the properties of synthetic elastomers contained in rubber compositions for tires, various strategies are possible. Among these, the introduction of novel chemical functions at the polymer chain end or along the polymer chain is one of the methods used.

The applicants are particularly concerned, within the context of the invention, with functionalization along the diene polymer chain. Various types of reactions on the unsaturations of diene polymers which make functionalization possible are known from the literature. Mention may be made of [4+2] cycloaddition reactions, of Diels-Alder reaction type, between a dienophile (maleic anhydride for example) and diene copolymers having conjugated dienes along the chain by virtue of the insertion of a conjugated triene comonomer (alloocimene) during the anionic copolymerization (EP 2 423 239 A1).

Mention may also be made of hydrosilylation reactions of a hydrosilane bearing a function (epoxide for example) on the pendant unsaturations of a diene polymer (FR 13/62946).

1,3-dipolar cycloaddition reactions in the presence of nitrile oxide or nitrone are also known for functionalization (WO 2012007441 A1, WO 2006045088 A2) or crosslinking of diene polymers (FR 1583406, WO 2006081415 A2).

Radical grafting of functional or non-functional thiols via photochemical or chemical catalysis (with or without radical initiator) belongs to these reactions for the functionalization of diene polymers (natural and synthetic rubber) in the same way as the cycloaddition or hydrosilylation reactions mentioned above. Thiol-ene coupling (reaction of a thiol onto a double bond) to polydienes offers a certain degree of versatility for molecular design. This is because the good tolerance of thiol-ene chemistry to numerous functional groups and the good availability of polydienes containing varied microstructures has made it possible to produce ranges of original materials by varying the nature of the grafted functionality.

The radical addition of thiols containing carboxyl, hydroxyl, epoxy and siloxy groups to polybutadienes has been widely studied since the end of the second world war.

The applicants are more particularly concerned, within the context of the invention, with obtaining a diene polymer bearing phosphorus-based functions along the chain.

Indeed, phosphorus-based polymers have recently begun to attract growing interest due to their usefulness in a wide range of applications, such as for example fuel cells (J. Fuel Cells, 2005, 5, (3), 355), electrolyte membranes (cation exchange membranes) (J. App. Poly. Sci, 1999, 74, 83), flame retardants (Macromolecules, 1998, 31, 1010; Rhoda Chimie WO 2003076531) additives for dental cements (J. Dent. Res, 1974, 53, (4), 867), biomaterials (orthopaedic applications) (J. Mater. Sci. Lett, 1990, 9, 1058; Macromol. Rapid Commun. 2006, 20, 1719-24), solubilization of medication (hydrogels for medication release) (J. Appl. Polym. Sci, 1998, 70, 1947), cell proliferation promoters (Fuji Photo Film Co. U.S. Pat. No. 6,218,075; Biomaterials. 2005, 26, 3663-3671) and corrosion-inhibiting agents in cooling systems (Macromolecules, 1998, 31, 1010). One of the modes for synthesizing phosphorus-based diene polymers known to those skilled in the art is chemical modification of diene polymers by radical grafting of phosphonate-functionalized thiols. The group of Pr. Boutevin (Polym. Bull. 1998, 41, 145-151) describes the radical grafting of a thiol, diethyl (3-mercaptopropyl)phosphonate (HS—(CH₂)₃—PO₃(Et)₂), onto a hydroxytelechelic polybutadiene (Mₙ=1200 g/mol and with 20% or 80% of 1,2-butadiene units) in THF with AIBN as radical initiator, at 70° C. for 6 hours.

It appears that to have a real benefit in terms of properties for an elastomer with phosphonate or phosphonic functions, in various applications, in particular in the field of tires, a high molar content of phosphorus-based units may prove to be necessary. However, increasing the molar content of phosphorus-based functions on the elastomer involves using large amounts of phosphonate- or phosphonic-functional thiols. The use of high proportions of thiol molecules bearing a phosphorus-based function has the drawback of changing the macrostructure more significantly in the case of high targeted molar contents of grafts. This change in macrostructure observed in the context of radical grafting is generally due to side reactions (radical-radical bimolecular coupling, transfer reactions, etc.); the proportion of these side reactions increasing with the targeted content of grafts. This change in macrostructure is often responsible for a degradation in the elastomeric properties of the polymer, and therefore for a lowering of its performance in the targeted application, such as for example in tires.

### SUMMARY

The technical problem posed by the prior art is that of having a simple and reproducible method which makes it possible to synthesize a polymer having a high molar content of phosphorus-based functions along the chain while overcoming the drawbacks linked to the use of high proportions of thiol molecules bearing a phosphorus-based function.

The inventors have now developed a novel phosphorus-based molecule which makes it possible to prepare diene polymers having a high molar content of phosphonate and/or phosphonic functions along the chain, while retaining the benefit of thiol-ene coupling by significantly limiting the change in macrostructure of the polymer linked to the grafting of high proportions of functions. Indeed, the inventors have synthesized a polyphosphorus-based polymer bearing a chain-end thiol function which may be grafted by thiol-ene coupling to a diene polymer. In this way, high molar contents of phosphonate and/or phosphonic functions are obtained on the polymer after grafting for a comparatively lower fraction of double bonds consumed in the polymer backbone than is the case with a thiol molecule bearing a single phosphorus-based function. This means that the macrostructure of the polymer, and hence its intrinsic properties, are better conserved after the grafting step.

A subject of the invention is a polyphosphorus-based polymer bearing a chain-end thiol function.

Another subject of the invention is a method for synthesizing such a polymer.

### DETAILED DESCRIPTION OF EXAMPLE EMBODIMENTS

In the present description, the term “phosphorus-based” is intended to mean, whether in relation to the function or to the polymer, that a group or a polymeric unit, depending on the case in question, comprises at least one phosphonate function, phosphonic hemiacid function or phosphonic diacid function. The term “a phosphonic function” is used to refer to a phosphonic hemiacid function or a phosphonic diacid function.

In the present description, “unit” of a polymer is intended to mean any unit derived from a monomer of the polymer backbone in question.

In the present description, “thiol-terminated” is intended to mean, in reference to the polyphosphorus-based polymer, that it bears a thiol function at a chain end.

In the present description, molar content or molar percentage of a unit in a polymer is used to define the number of moles of these units in the polymer relative to the total number of moles of units present in said polymer.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

According to the invention, the polyphosphorus-based polymer bearing an end thiol function is a thiol derivative, the polymer chain of which comprises units bearing at least one pendant phosphonate function and/or at least one pendant phosphonic function along the chain. The polymer chain may be any homopolymer obtained by polymerization of a monomer bearing at least one phosphorus-based function or of any copolymer of one or more monomers bearing at least one phosphorus-based function, with one another or with one or more comonomers.

According to the invention, the polyphosphorus-based polymer bearing a chain-end thiol function may be represented by the formula R—P—SH, R representing an alkyl, acyl, aryl, alkenyl or alkynyl group, a saturated or unsaturated, optionally aromatic carbon-based ring, a saturated or unsaturated, optionally aromatic heterocycle, or a polymer chain, and P representing the polyphosphorus-based chain.

According to one variant of the invention, the thiol-terminated polyphosphorus-based polymer corresponds to the following general formula (I):

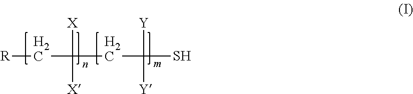

with
   m denoting an integer greater than or equal to 2 and n denoting an integer greater than or equal to 0, with the proviso that, when n is other than 0, n and m may be identical or different, preferably greater than 2 and preferably less than 500,
   R represents;
      (i) an alkyl, acyl, aryl, alkenyl or alkynyl group,
      (ii) a saturated or unsaturated, optionally aromatic carbon-based ring,
      (iii) a saturated or unsaturated, optionally aromatic heterocycle, or these groups and rings (i), (ii) and (iii) possibly being substituted by substituted phenyl groups, substituted aromatic groups or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R′ representing an alkyl or aryl group,
      (iv) a polymer chain,
   X and X′, which are identical or different, representing H a halogen or an R₁, OR₁, OCOR₁, NHCOH, OH, NH₂, NHR₁, N(R₁)₂, (R₁)₂N+O—, NHCOR₁, CO₂H, CO₂R₁, CN, CONH₂, CONHR or CON(R₁)₂ group, in which groups R₁ is selected from alkyl, aryl, aralkyl, alkylaryl, alkene or organosilyl groups which are optionally perfluorinated and optionally substituted by one or more carboxyl, epoxy, hydroxyl, alkoxy, amino, halogen or sulphonic groups,
   Y and Y′, which are identical or different, are such that either Y or Y′, or both, comprise at least one phosphorus-based —P(O)(OR₂)(OR₃) function, R₂ and R₃, which are identical or different, representing a hydrogen atom or an alkyl, optionally haloalkyl, radical.

According to variants of the invention, the thiol-terminated polyphosphorus-based polymer may consist of a type of monomer unit comprising Y and Y′. The thiol-terminated polyphosphorus-based polymer is therefore a thiol derivative of a homopolymer of a monomer bearing at least one phosphorus-based function.

According to variants of the invention, the thiol-terminated polyphosphorus-based polymer may consist of several types of monomer units comprising Y and Y′, Y and Y′ then being different from one type of unit to another. The thiol-terminated polyphosphorus-based polymer is therefore a thiol derivative of a copolymer of several monomers bearing at least one phosphorus-based function. The sequence of the various monomer units comprising Y and Y′ may be random or block.

According to variants of the invention, the thiol-terminated polyphosphorus-based polymer may consist of one or more types of monomer units comprising Y and Y′, and one or more types of monomer units comprising X and X′; Y and Y on the one hand, and X and X′ on the other hand then being different from one type of unit to another.

The thiol-terminated polyphosphorus-based polymer is therefore a thiol derivative of a copolymer of one or more monomers bearing at least one phosphorus-based function and one or more comonomers comprising X, X′. The sequence of the various monomer units comprising X, X′ on the one hand, and Y and Y′ on the other hand, may be random or block.

According to the invention, the term “alkyl” denotes a linear or branched hydrocarbon-based radical with 1 to 20 carbon atoms, such as methyl, ethyl, propyl, isopropyl, butyl, tert-butyl, isobutyl, pentyl, hexyl, heptyl, octyl, nonyl, decyl, undecyl, dodecyl, tridecyl, tetradecyl, pentadecyl, hexadecyl, heptedecyl, octadecyl, nonadecyl or icosyl.

“Alkenyl” is intended to mean a linear or branched hydrocarbon-based chain having from 2 to 20 carbon atoms, comprising one or more double bonds. Examples of particularly preferred alkenyl groups are the alkenyl groups bearing just one double bond, such as —CH₂—CH₂—CH═C(CH₃)₂, vinyl or allyl.

“Alkynyl” is intended to mean a linear or branched hydrocarbon-based chain having from 2 to 20 carbon atoms, comprising one or more triple bonds. Examples of particularly preferred alkynyl groups are the alkynyl groups bearing just one triple bond, such as —CH₂—CH₂—C≡CH.

“Cycloalkyl” is intended to mean saturated hydrocarbon-based groups which may be monocyclic or polycyclic and comprise from 3 to 12 carbon atoms, preferably from 3 to 8. The monocyclic cycloalkyl groups such as cyclopropyl, cyclobutyl, cyclopentyl, cyclohexyl cycloheptyl, cyclooctyl, cyclononyl, cyclodecyl, cycloundecyl and cyclododecyl are more particularly preferred.

“Cycloalkenyl” is intended to mean, according to the invention, a group derived from a cycloalkyl group as defined above, having one or more double bonds, preferably one double bond.

“Cycloalkynyl” is intended to mean, according to the invention, a group derived from a cycloalkyl group as defined above, having one or more triple bonds, preferably one triple bond.

“Aryl” is intended to mean a monocyclic or bicyclic aromatic hydrocarbon-based group comprising 6 to 10 carbon atoms, such as phenyl or naphthyl.

“Alkaryl” is intended to mean an alkyl group as defined above, substituted by an aryl group.

“Aralkyl” is intended to mean an alkyl group as defined above, substituted by an aryl group.

“Alkoxy” is intended to mean an O-alkyl group generally having from 1 to 20 carbon atoms, especially methoxy ethoxy, propoxy and butoxy.

The heterocyclic group (iii) denotes saturated, or preferably unsaturated, monocyclic or bicyclic 5- to 12-membered carbon-based rings having 1, 2 or 3 endocyclic heteroatoms selected from O, N and S. These are generally derivatives of the heteroaryl groups. Generally, “heteroaryl” is intended to mean 5- to 7-membered monocyclic aromatic groups or 6- to 12-membered bicyclic aromatic groups comprising one, two or three endocyclic heteroatoms selected from O, N and S. Examples thereof are furyl, thienyl, pyrrolyl, oxazolyl, isoxazolyl, thiazolyl isothiazolyl, imidazolyl, pyrazolyl, oxadazolyl, triazolyl, thiadiazolyl, pyridyl, pyridazinyl, pyrazinyl and triazinyl groups. Preferably, when it is unsaturated the heterocycle comprises just one double bond. Preferred examples of unsaturated heterocycles are dihydrofuryl, dihydrothienyl, dihydropyrrolyl, pyrrolinyl oxazolinyl, thiazolinyl, imidazolinyl, pyrazolinyl, isoxazolinyl, isothiazolinyl, oxadiazolinyl, pyranyl and the monounsaturated derivatives of piperidine, dioxane, piperazine, trithiane, morpholine, dithiane or thiomorpholine, and also tetrahydropyridazinyl, tetrahydropyrimidinyl, and tetrahydrotriazinyl.

According to variants of the invention, R is as defined in the documents WO 98/58974, WO 00/75207 and WO 01/42312 (definition of R₁), WO 98/01478 and WO 99/31144 (definition of R), or WO 02/26836 (definition of R₁).

Among these variants, R is more particularly a CNCH₂-cyanomethyl group, CH₃(C₃H₅)CH-1-phenylethyl group or CH(CO₂CH₃)CH-methylpropionyl group.

The molar fraction of monomer units comprising X and X′ may be zero, and generally ranges from 0 to 0.5, preferably from 0 to 0.25 and better still from 0 to 0.1.

Among the monomers from which the units bearing phosphorus-based functions in Y and Y′ which may be used in the present invention are derived, mention may especially be made of vinylphosphonic acid, vinylphosphonic acid dimethyl ester, vinylphosphonic acid bis(2-chloroethyl) ester, vinylidenediphosphonic acid, vinylidenediphosphonic acid tetraisopropyl ester, alpha-styrenephosphonic acid, dimethyl-p-vinylbenzylphosphonate, diethyl-P-vinylbenzylphosphonate, dimethyl(methacryloyloxy)methyl phosphonate, diethyl(methacryloyloxy)methyl phosphonate, diethyl 2-(acrylamido)ethylphosphonate, and more generally any unsaturated styrene, acrylate or methacrylate, acrylamido or methacrylamido, vinyl or allyl monomer bearing at least one dialkylphosphonate, phosphonic diacid or hemiacid —P(OH)(OR) group, or a mixture of these monomers. Preferably, vinylphosphonic acid dimethyl ester and dimethyl-p-vinylbenzylphosphonate will be used.

Among the monomers from which the units substituted by X and X′ which may be used in accordance with the present invention are derived, mention may be made of the hydrophilic (h) or hydrophobic (H) monomers selected from the following monomers. Among the hydrophilic (h) monomers, mention may be made of:
vinyl alcohol resulting from the hydrolysis of vinyl acetate, for example.
neutral acrylamido monomers such as acrylamide, N,N-dimethylacrylamide and N-isopropylacrylamide.
cyclic amides of vinylamine, such as N-vinylpyrrolidone and vinylcaprolactam,
ethylenic unsaturated monocarboxylic and dicarboxylic acids such as acrylic acid, methacrylic acid, itaconic acid, maleic acid or fumaric acid.
ethylenic monomers comprising a sulphonic acid group or one of the alkali metal salts or ammonium salts thereof, such as for example vinylsulphonic acid, vinylbenzenesulphonic acid, alpha-acrylamidomethylpropanesulphonic acid or 2-sulphoethyl methacrylate, or
monomers selected from aminoalkyl (meth)acrylates, aminoalkyl (meth)acrylamides, monomers comprising at least one secondary, tertiary or quaternary amine function, diallyl dialkyl ammonium salts such as dimethylaminoethyl (meth)acrylate, dimethylaminopropyl (meth)acrylate, dimethylaminopropyl (meth)acrylamide, 2-vinylpyridine, 4-vinylpyridine and dialkyldimethyl ammonium chloride.

Preferably, the hydrophilic (h) monomer units are selected from acrylic acid (AA), dimethylaminopropyl acrylamide and N-vinylpyrrolidone.

Among the hydrophobic (H) monomers, mention may be made of:
styrene-derived monomers such as styrene, alpha-methylstyrene, para-methylstyrene or para-tert-butylstyrene, or
esters of acrylic acid or of methacrylic acid with optionally fluorinated C₁-C₁₂ preferably C₁-C₈ alcohols such as for example methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate, isobutyl methacrylate,
vinyl nitriles containing from 3 to 12 carbon atoms, especially acrylonitrile or methacrylonitrile,
vinyl esters of carboxylic acids, such as vinyl acetate (VAc), vinyl versatate or vinyl propionate,
vinyl halides or vinylidene halides, for example vinyl chloride, vinylidene chloride and vinylidene fluoride, and
diene monomers, for example butadiene or isoprene.

Preferably, the hydrophobic monomer units (H) of the copolymers of the invention are butadiene, isoprene, butyl acrylate and styrene.

The thiol-functional polyphosphorus-based polymer as defined above has a mean number of units at least equal to 2 and at most equal to 1000.

The chain-end thiol-functional polyphosphorus-based polymer may be obtained by any method enabling chain-end functionalization by a thiol function of any polyphosphorus-based polymer obtained by homopolymerization of a monomer bearing at least one phosphorus-based function or by copolymerization of one or more monomers bearing at least one phosphorus-based function, with one another or with one or more comonomers. Depending on the methods, the functionalization may be concomitant to the polymerization or posterior thereto.

Numerous techniques are known for the synthesis of polymers functionalized with thiols at their end. Mention is made, for example, of the chemical modification of a hydroxy-terminated polymer by mercaptoacetic acid (Du et al., J. Appl. Polym, Sci. 2003, 90, 2, 594-607) or else the hydrolysis of a thiocarbonylthio end group of a polymer synthesized by RAFT (reversible addition fragmentation chain transfer polymerization), Moad et al., Aust. J. Chem. 2012, 65, 985-1076) (Bee at al., Reactive and Functional Polymers, 2011, 71, 2, 187-194). In particular, by using specific thiocarbonylthio compounds, these same RAFT polymers are converted into macrothiols by simple thermal elimination (WO 2002090424 A1, Rhodia Chimie and Destarac et al., ACS Symp. Ser, 944, American Chemical Society 2006. Matyjaszewski. K., Ed. “Controlled/Living Radical Polymerization: From Synthesis to Materials”, p. 564.).

According to one advantageous variant of the invention, the chain-end thiol-functional polyphosphorus-based polymer is obtained by RAFT- or MADIX-controlled radical (co)polymerization of at least one monomer bearing at least one phosphorus-based function in the presence of a source of free radicals and a thiocarbonylthio chain transfer agent of general formula (II):

R—S(C═S)—Z (II)
in which:
   R represents:
   (i) an alkyl, acyl, aryl, alkenyl or alkynyl group,
   (ii) a saturated or unsaturated, optionally aromatic carbon-based ring,
   (iii) a saturated or unsaturated, optionally aromatic heterocycle, or these groups and rings (I), (ii) and (iii) possibly being substituted by substituted phenyl groups, substituted aromatic groups or alkoxycarbonyl or aryloxycarbonyl (—COOR′), carboxyl (—COOH), acyloxy (—O₂CR′), carbamoyl (—CONR′₂), cyano (—CN), alkycarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO. PPO) or cationic substituents (quaternary ammonium salts), R′ representing an alkyl or aryl group,
   (iv) a polymer chain.
Z is an oxygen atom, a carbon atom, a sulphur atom, a nitrogen atom or a phosphorus atom, these atoms being substituted by one, two or three hydrocarbon-based radicals R″ so as to have the appropriate valency, possibly comprising at least one heteroatom, such that R″ represents a group as defined above for R.

According to variants of the invention, R and R″ are as defined in the documents WO 98/58974, WO 00/75207 and WO 01/42312 (definition of R₁ or R₂), WO 98/01478 and WO 99/31144 (definition of R or of Z and Ei, respectively), or WO 02126836 (definition of R¹ or nitrogen-based group).

According to variants of the invention, in general formula R—S(C═S)—Z. R is more particularly a CNCH₂-cyanomethyl group, CH₃(C₆H₅)CH-1-phenylethyl group or CH₃(CO₂CH₃)CH— methylpropionyl group.

According to variants of the invention, in general formula R—S(C═S)—Z, Z denotes an OR′ group with R′ denoting a C₁-C₈, more preferentially still C₁-C₂ alkyl radical.

Thus, according to variants of the invention, the polyphosphorus-based polymers of Formula I may be obtained by RAFT- or MADIX-controlled radical polymerization of the monomers comprising Y and Y′ and, where appropriate, the monomers comprising X and X′, listed above.

The preferential aspects and variants above may be combined with one another.

A thiocarbonylthio transfer agent corresponding to the general formula R—S—(C═S)—Z may be synthesized in a way which is known to those skilled in the art.

The RAFT or MADIX polymerization initiator may be selected from the initiators conventionally used in radical polymerization.

Thus, transfer agents or methods which may be used for carrying out the synthesis of the polyphosphorus-based polymer bearing a thiol function are especially described in the following documents:
the methods and agents of applications WO 98/58974, WO 00/75207 and WO 01/42312, which use a radical polymerization controlled by control agents of xanthate type (—S—(C═S)—O— group),
the method and the agents of radical polymerization controlled by control agents of dithioester type (—S—(C═S)—S—C group) or trithiocarbonate type (—S—(C═S)—S— group) of application WO 98/01478,
the method and the agents of radical polymerization controlled by control agents of dithiocarbamate type (—S—(C═S)—N group) of application WO 99/31144,
the method and the agents of radical polymerization controlled by control agents of dithiocarbazate type (—S—(C═S)—N group) of application WO 02/26836,
the agents of xanthate, dithiocarbonate and/or trithiocarbonate type described in documents WO02070571; WO2001060792; WO2004037780; WO2004083169; WO02003066685; WO2005068419; WO2003062280; WO2003055919; WO2006023790, and the methods using same.

One of the advantages of the RAFT or MADIX polymerization method is the possibility of controlling the polyphosphorus-based polymer length by adjusting the molar ratio of the monomer and of the transfer agent. The molar ratio of the monomer to the transfer agent is generally at least 2. According to variants of the invention linked to the choice of phosphorus-based monomer, this ratio is at most 1000.

At the end of polymerization, the product is predominantly of general formula R—P—S—(C═S)—Z, P denoting the polyphosphorus-based polymer chain.

The thiol derivative R—P—SH is obtained by chemical modification of this thiocarbonylthio-terminated product in a conventional way known to those skilled in the art. Among the methods envisaged, mention will advantageously be made of the aminolysis reaction, generally carried out with primary or secondary amine compounds. Even more advantageously, the thiol-terminated polyphosphorus-based polymer R—P—SH is formed directly by thermolysis of specific thiocarbonylthio groups, for example xanthates derived from secondary alcohol.

The thiol-terminated polyphosphorus-based polymer is most particularly suited to participating in a thiol-ene coupling reaction. The carbon-carbon double bonds are advantageously unsaturations of a diene polymer, thereby making it possible to graft the polyphosphorus-based polymers of the invention onto diene polymers. It is thus possible to prepare polymers with high contents of phosphonate or phosphonic functions while significantly reducing the changes in macrostructure of the polymers and the side reactions occurring during grafting of monophosphorus-based thiol molecules, with a view to achieving the same content of functions in the polymer.

The abovementioned characteristics of the present invention, and also others, will be better understood on reading the following description of several exemplary embodiments of the invention, given by way of non-limiting illustration.

### Examples Measurements Used

The elastomers are characterized before curing, as indicated below.

Size-Exclusion Chromatography

The number-average molar masses Mn of the polymers, and also their dispersities, were obtained by size-exclusion chromatography (SEC) with tetrahydrofuran (THF) as eluent at 1 ml/min. Calibration is carried out with polystyrene standards (PS) having molar masses of between 1200 and 512 800 g·mol⁻¹. The SEC chain is equipped with an RI Waters 2414 detector and a set of 2 columns (Shodex KF-802.5 and KF-804) thermostatically controlled at 35° C.

Glass Transition Temperature

The analyses for determining glass transition temperature were carried out with a Netzsch DSC apparatus (Phoenix).

An aluminium crucible comprising 5 to 10 mg of sample is placed on a platinum boat. The rate of temperature rise used for all the samples is 10° C.·min⁻¹. The analyses were carried out under nitrogen.

Nuclear Magnetic Resonance Spectroscopy

¹H NMR, ³¹P NMR and ¹³C NMR analyses were recorded on a 300 MHz Bruker spectrometer at ambient temperature and using CDCl₃ as solvent. Chemical shifts are given in ppm. The monomer conversions are determined by ¹H NMR and ³¹P NMR.

### EXAMPLE EMBODIMENTS OF THE INVENTION

### Example 1: Synthesis of a Xanthate with C4 Cyanomethyl Function

Reaction Scheme

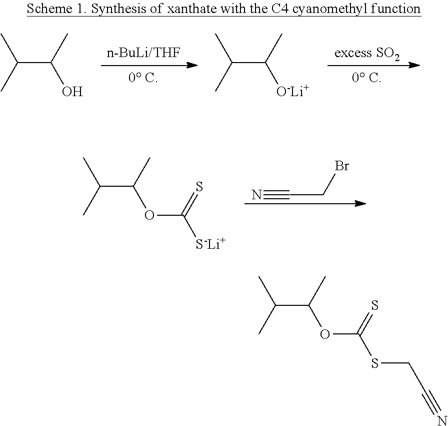

6 g (6.81×10⁻² mol) of 3-methylbutanol are dissolved in 45 ml of THF in a 500 ml round-bottomed flask. A solution of BuLi (1.6 M in hexane) (46.5 ml, 7.44×10⁻² mol) is added dropwise to the reaction mixture at 0° C. The reaction is left, with stirring, for 30 minutes. Carbon disulphide (30 ml, 4.96×10⁻¹ mol) is added dropwise to the reaction medium at 0° C. The reaction mixture is then maintained under magnetic stirring for 30 minutes at 0° C. 11.6 g (13.62×10⁻² mol) of bromoacetonitrile is added dropwise to the reaction mixture, then the solution is kept under stirring for 15 h. After evaporating the THF, the residue is purified by CH₂Cl₂ water (1:1) extraction. The CH₂Cl₂ solution is evaporated under vacuum. After purification on a chromatography column (eluent: 95/5 petroleum ether/ethyl acetate) and evaporation, the product is obtained in the form of a yellowish oil with a final yield of 86%.

¹H NMR (300 MHz, CDCl₃, δ=ppm): 5.58 (1H, m, O—CHCH₃), 3.85 (2H, s, NC—CH₂—S—C═S), 2.02 (1H, m, (—CH(CH₃)₂), 1.33 (3H, d, O—CHCH₃), 0.96 (6H, d, (—CH(CH₃)₂).

¹³C NMR (300 MHz, CDCl₃, δ=ppm): 208.6 (S═CSCH—), 115.5 (NC—CH₂—S—C═S), 87.8 (O—CHCH₃), 32.7 ((—CH(CH₃)₂), 21.1 (NC—CH₂—S—C═S), 18.1 (—CH(CH₃)₂), 17.9 (O—CHCH₃), 15.8 (O—CHCH₃).

### Example 2: Synthesis of the Dimethyl Vinylphosphonate DMVP-C4 Monoadduct

Reaction Scheme

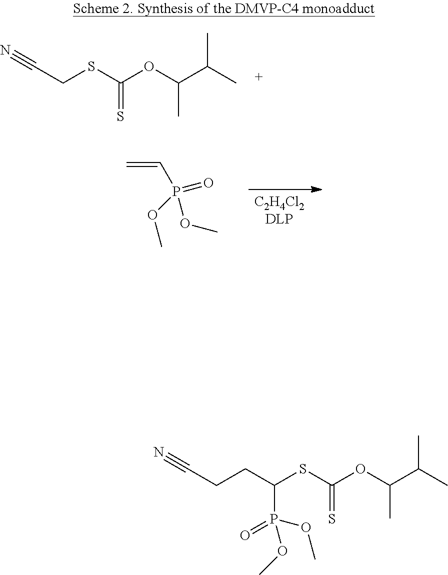

The C4 xanthete (2.76 g, 13.59×10⁻² mol), the dimethyl vinylphosphonate (1 g, 7.35×10⁻³ mol) and the 1,2-dichloroethane solvent (6 ml) are introduced into a 25 ml round-bottomed flask surmounted by a reflux condenser. The mixture is degassed under argon for 15 minutes. The reaction mixture is then maintained at the reflux point of the solvent (95° C.) and under magnetic stirring for 7 hours. 5 mol % of dilauroyl peroxide are added every 60 minutes up to 25 mol %. After purification on a chromatography column (eluent: ethyl acetate) and evaporation, the final yield of the synthesis is 65%.

¹H NMR (300 MHz, CDCl₃, δ=ppm): 5.58 (1H, m, O—CHCH₃), 4.35 (1H, m, NC—CH₂—CH₂—CH₃—S—C═S), 3.82 (3H, s, P═(OCH₃)₂), 2.62 (2H, m, NC—CH₂—CH₂—CH₁—S—C═S), 2.45-2.21 (2H, m, NC—CH₂—CH₂—CH₁—S—C═S), 2.03 (—CH(CH₃)₂), 1.35 (3H, d, O—CHCH₃), 0.95 (6H, d, (—CH(CH₃)₂).

³¹P NMR (300 MHz, CDCl₃, 5=ppm): 24.6 (1P, d, P═(OCH₃)₂).

¹³C NMR (300 MHz, CDCl₃, S=ppm): 210.7 (S═CSCH—). 119.1 (NC—CH₂—CH₂—CH₁—S—C═S), 88.0 (O—CHCH₃), 54.2 (P═(OCH₃)₂), 44.4 and 42.6 (NC—CH₂—CH₂—CH₁—S—C═S), 32.7 ((—CH(CH₃)₂), 26.6 (NC—CH₂—CH₂—CH₁—S—C═S), 19.1 (—CH(CH₃)₂), 16.4 (O—CHCH₃), 15.1 (NC—CH₂—CH₂—CH₂—CH₂—S—C═S).

### Example 3: Aminolysis of the DMVP-C4 Monoadduct

Reaction Scheme

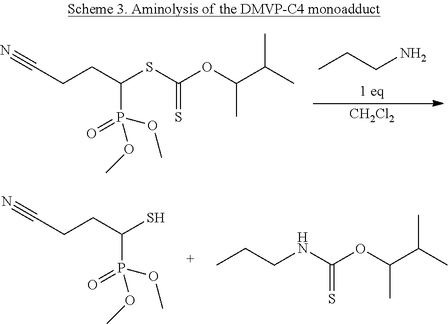

200 mg (2.94×10⁻⁴ mol) of DMVP-C4 monoadduct are dissolved in 6 ml of dichloromethane in a 25 ml round-bottomed flask. The round-bottomed flask is placed in an ice bath, degassed under argon for 15 minutes, then kept in darkness under an inert atmosphere until the monoadduct has completely dissolved. A second solution containing 1 ml of propylamine in 40 ml of dichloromethane is prepared then degassed under argon for 15 minutes. 1 ml (2.94×10⁻⁴ mol) of this stock solution is added dropwise at 0° C. to the reaction mixture containing the monoadduct. The reaction is left, with stirring, for 60 minutes. After purification on a chromatography column (eluent: ethyl acetate) and evaporation, the final yield of the aminolysis is 35%.

³¹P NMR (300 MHz, CDCl₃, δ=ppm): 26.3 (1P, s, P═(OCH₃)₂).

### Example 4: Thermolysis of the DMVP-C4 Monoadduct

Reaction Scheme

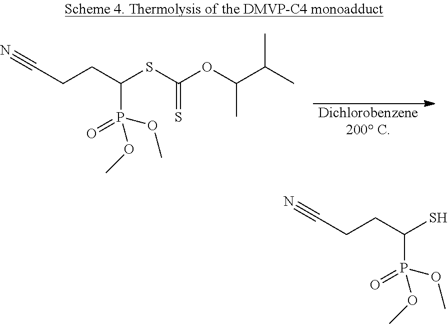 [SMILES: COP(=O)(OC)C(CCC#N)SC(=S)OC(C)C(C)C ; "Dichlorobenzene200° C." ; COP(=O)(OC)C(S)CCC#N]

The DMVP-C4 monoadduct (250 mg, 7.37×10⁻⁴ mol) and the 1,2-dichlorobenzene solvent (3 ml) are introduced into a 25 ml round-bottomed flask surmounted by a reflux condenser. The reaction mixture is degassed under argon for 15 minutes then maintained at the reflux point of the solvent (200′C) in darkness for 5 minutes. The yield of the thermolysis is 70%.

³¹P NMR (300 MHz, CDCl₃, 5=ppm): 26.3 (1P, s, P═(OCH₅)₂).

### Example 5: Synthesis of the PDMVP Oligomers

Reaction scheme

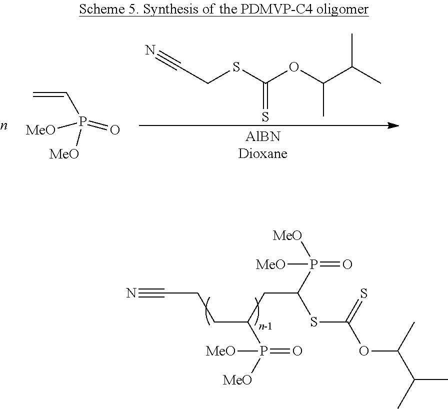

Polymerization is carried out according to the following protocol: the C4 xanthate (470 mg, 2.31×10⁻³ mol), the dimethyl vinylphosphonate (3 g, 2.2×10⁻² mol), the AIBN (72 mg, 4.38×10⁻⁴ mol) and 4.6 g of 1,4-dioxane are placed in a Schlenk tube. The solution is degassed under argon for 15 minutes then placed in a bath heated beforehand to 70° C. The reaction is left, with stirring, for 24 hours. The reaction mixture is purified by drying under reduced pressure at 80° C. and by washing with dichloromethane to eliminate the residual monomer and the dioxane. The conversion obtained is 50% and the molar mass, determined by ³¹P NMR, is 720 g/mol (M_{n theo}=750 g/mol).

### Example 8: Thermolysis of the PDMVP-C4 Oligomers

Reaction Scheme

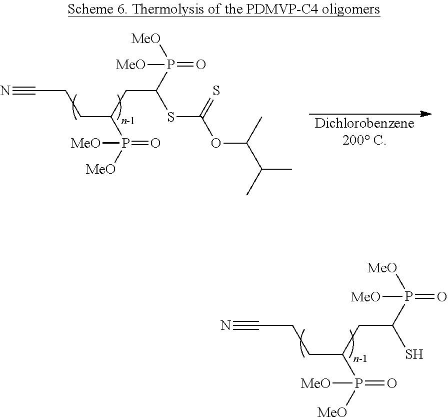

The PDMVP-C4 (250 mg, 3.47×10⁻⁴ mol) and the 1,2-dichlorobenzene solvent (3 ml) are introduced into a 25 ml round-bottomed flask surmounted by a reflux condenser. The reaction mixture is degassed under argon for 15 minutes then maintained at the reflux point of the solvent (200° C.) in darkness for 15 minutes. The yield of the thermolysis is 72% (determined by ³¹P NMR).

### Example 7: Thermolysis of the DMVP-C4 Monoadduct Followed by Grafting to SBR

Reaction Scheme

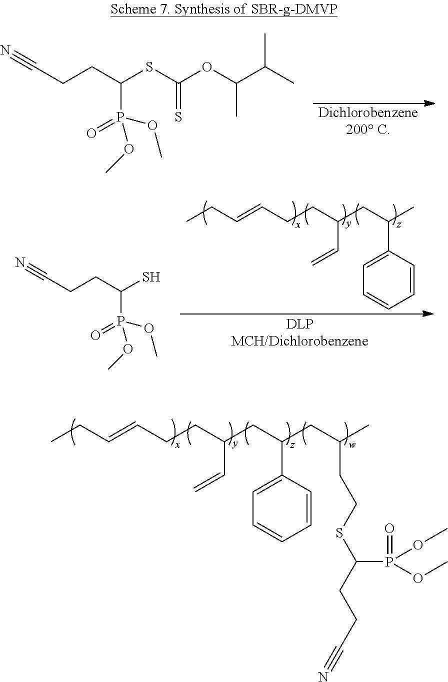

The DMVP-C4 monoadduct (250 mg, 7.37×10⁻⁴ mol) and the 1,2-dichlorobenzene solvent (3 ml) are introduced into a 50 ml round-bottomed flask surmounted by a reflux condenser. The mixture is degassed under argon for 15 minutes then maintained at the reflux point of the solvent (200° C.) in darkness for 5 minutes. 500 mg of SBR (Mₙ=235 900 g/mol, dispersity [symbol] (M_{w}/Mₙ)=1.24, 75% PB) are dissolved in 15 ml of methylcyclohexane. The latter SBR is already antioxidized with A02246 (2,2′-methylenebis(4-methyl-6-tert-butylphenol)). This second solution is added to the monoadduct, then the reaction medium is degassed under argon for 15 minutes. The solution is then heated to 75° C. A solution of 10 mg of DLP in 20 ml of methycyclohexane is prepared, then degassed under argon for 15 minutes. 1 ml (1,25×10⁶ mol) of this stock solution is added via a syringe into the reaction medium. After 3 h of reaction, the mixture is cooled then precipitated from methanol. The polymer is dissolved in dichloromethane then antioxidized with 1 ml of a 10 g/I solution of A02246. The polymer is then dried under vacuum at 60° C. The grafting yield is 37.5% (determined by ¹H NMR).

Table 1 below summarizes the characteristics of the polymers synthesized by grafting the DMVP.

TABLE 1
Synthesis of SBR-g-DMVP by thiol-ene grafting. [SBR]₀ = 1.3 × 10⁻⁴ mol · l⁻¹,
[DLP]₀ = 0.2%/[DMVP]₀, T = 75° C., t = 3 h

| | | | | | % | | | | |
|---|---|---|---|---|---|---|---|---|---|
| | | | | | consumption | Molar fraction | Mn^{b} | | |
| | [DMVP-C4]₀ | % target graft/ | % exp. graft/ | Exp. graft | of | phosphonate^{a}/ | (g · mol⁻¹) | | Tg |
| Example 7 | mmol l⁻¹ | unsaturations | unsaturations^{a} | yield (%)^{a} | unsaturations^{a} | deiene polymer | (PS) | [symbol] | (° C.) |
| Non-grafted | 00 | 00 | 00 | 00 | 00 | 00 | 235900 | 1.24 | −19.8 |
| SBR | | | | | | | | | |
| SBR 7a | 6.3 | 1.36 | 0.925 | 68 | 2.95 | 3.6 | 250800 | 1.23 | −21.1 |
| SBR 7b | 57.9 | 12.5 | 4.7 | 37.5 | 16.33 | 18.2 | 400600 | 1.44 | −23.8 |

^{a}determination by ¹H NMR,
^{b}determination by SEC-RI in THF with PS standards.

### Example 8: Thermolysis of PDMVP-C4 Followed by Grafting to SBR

Reaction Scheme

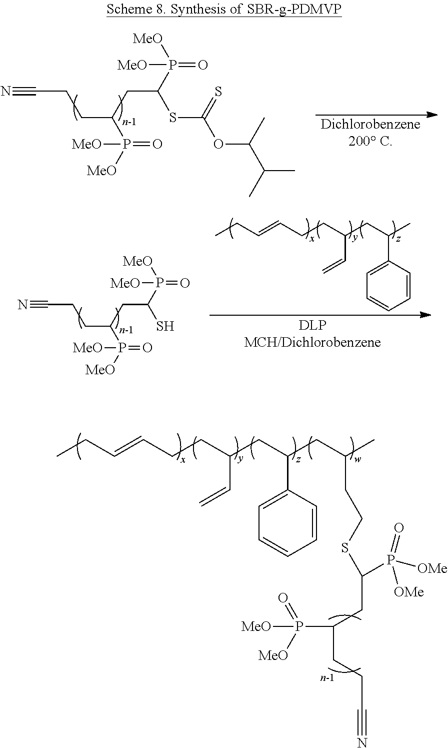

The PDMVP-C4 oligomer (250 mg, 3.47×10⁻⁴ mol) end the 1,2-dichlorobenzene solvent (3 ml) are introduced into a 50 ml round-bottomed flask surmounted by a reflux condenser. The mixture is degassed under argon for 15 minutes then maintained at the reflux point of the solvent (200° C.) in darkness for 5 minutes. 500 mg of SBR (M=235 900 g/mol, E)=1.24, 75% PB) are dissolved in 15 ml of methylcyclohexane. The latter SBR is already antioxidized with A02246 (2,2′-methylenebis(4-methyl-6-tert-butylphenol)). This second solution is added to the PDMVP solution, then the reaction medium is degassed under argon for 15 minutes. The solution is then heated to 75° C. A solution of 10 mg of DLP in 20 ml of methycyclohexane is prepared, then degessed under argon for 15 minutes. 1 ml (1.25×10⁻⁸ mol) of this stock solution is added via a syringe into the reaction medium. After 3 h of reaction, the mixture s cooled then precipitated from methanol. The polymer is dissolved in dichloromethane then antioxidized with 1 ml of a 10 g/l solution of AO2246. The polymer is then dried under vacuum at 60′C. The grafting yield is 48.5% (determined by ¹H NMR).

Table 1 below summarizes the characteristics of the polymers synthesized by grafting the DVMP.

TABLE 2
Synthesis of SBR-g-PDMVP by thiol-ene grafting. [SBR]₀ = 1.3 × 10⁻⁴ mol · l⁻¹,
[PDMVP-C4]₀ = 29.2 × 10⁻³ mol · l⁻¹, [DLP]₀ = 0.2%/[PDMVP]₀, T = 75° C., t = 3 h.

| | [PDMVP- | | | | % consumption | Molar fraction | | | |
|---|---|---|---|---|---|---|---|---|---|
| | C4]₀ mmol | % target graft/ | % exp. graft/ | Exp. graft | of | phosphonate^{a}/ | Mn^{b} (g · mol⁻¹) | | Tg |
| Example 8 | l⁻¹ | unsaturations | unsaturations^{a} | yield (%)^{a} | unsaturations^{a} | deiene polymer | (PS) | [symbol] | (° C.) |
| Non- | 00 | 00 | 00 | 00 | 00 | 00 | 235900 | 1.24 | −19.8 |
| grafted | | | | | | | | | |
| SBR | | | | | | | | | |
| SBR 8a | 3.7 | 1.05 | 0.7 | 66.5 | 2.2 | 12.2 | 239800 | 1.25 | |
| SBR 8b | 23.1 | 6.6 | 3.2 | 48.5 | 8.1 | 55.8 | 243000 | 1.26 | −34.1 |

^{a}determination by ¹H NMR,
^{b}determination by SEC-RI in THF with PS standards.

### Results

In comparison to the use of a thiol-terminated monophosphonate (example 7), grafting thiol-terminated polyphosphonates (example 8) makes it possible to obtain a phosphonate-modified diene polymer having high contents of phosphonate functions without actually having to target high degrees of grafting.

The use of small phosphonate-functional thiol molecules as described in example 7 has the drawback of changing the macrostructure in the case of high degrees of grafting.

In the case in which a low degree of grafting of the unsaturations of the diene elastomer is targeted, retention of the macrostructure of the final polymer is observed (entry 2, table 1 of example 7). However, in this case the molar fraction of the phosphonate functions in the final polymer is low (3.6%).

In order to obtain a diene polymer having high contents of phosphonate functions, a high degree of grafting of the unsaturations of the diene elastomer was targeted. The final polymer thus has a high molar fraction of phosphonate functions (18.2%). However, in this case the grafting reaction is accompanied by a change in the macrostructure, which is due to side reactions (bimolecular coupling, transfer reactions, etc.), the proportion of which increases with the targeted graft content. This is illustrated through the too high change in Mₙ (400 600 g·mol⁻¹), in dispersity ( [symbol] =1.44), and in the consumption of double bonds in the diene elastomer (table 1, entry 3 of example 7).

Advantageously, the use of a polyphosphorus-based polymer, in this instance polyphosphonate, bearing a chain-end thiol function, makes it possible to overcome the drawbacks linked to the use of small thiol-functionalized phosphonate molecules. This is because the use of polyphosphonate polymers makes it possible to obtain a modified diene polymer having a high molar content of phosphonate functions along the chain by targeting low degrees of grafting and without modifying the macrostructure of the final polymer.

This is illustrated in table 2, entry 2 of example 8. Indeed, it becomes possible to graft high molar contents of phosphonate functions (12.2%) without having to target a high content of the unsaturations of the diene elastomer. In this case, the grafting makes it possible to conserve the macrostructure of the final polymer (Mn=239 800 g·mol⁻¹, [symbol] =1.25).

It is also possible to increase the molar fraction of the phosphonate functions in the final diene polymer to achieve a very high content of 55.8% (table 2, entry 3 of example 8) without observing a change in the macrostructure of the final polymer (Mₙ=243 000 g·mol⁻¹, [symbol] =1.26) which was not the case with the monophosphonate bearing the thiol function of example 7

1. A polyphosphorus-based polymer bearing a chain-end thiol function, the polymer chain of which comprises units bearing at least one phosphonate function and/or at least one phosphonic function.

2. The polyphosphorus-based polymer bearing a chain-end thiol function according to claim 1, wherein the polyphosphorus-based polymer corresponds to the formula R—P—SH, R representing an alkyl, acyl, aryl, alkenyl or alkynyl group, a saturated or unsaturated, optionally aromatic carbon-based ring, a saturated or unsaturated, optionally aromatic heterocycle, or a polymer chain, P representing the polyphosphorus-based chain, comprising units bearing at least one phosphonate function and/or at least one phosphonic function, S representing a sulphur atom and H representing a hydrogen atom.

3. The polyphosphorus-based polymer bearing a chain-end thiol function according to claim 2, wherein the polyphosphorus-based polymer corresponds to the following general formula (I): 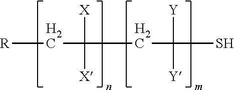
with
m denoting an integer greater than or equal to 2 and n denoting an integer greater than or equal to 0, with the proviso that, when n is other than 0, n and m may be identical or different,
R represents:
(i) an alkyl, acyl, aryl, alkenyl or alkynyl group,
(ii) a saturated or unsaturated, optionally aromatic carbon-based ring,
(iii) a saturated or unsaturated, optionally aromatic heterocycle, or these groups and rings (i), (ii) and (iii) possibly being substituted by substituted phenyl groups, substituted aromatic groups, or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R′ representing an alkyl or aryl group,
(iv) a polymer chain,
X and X′, which are identical or different, representing H, a halogen or an R₁, OR₁, OCOR₁, NHCOH, OH, NH₂, NHR₁, N(R₁)₂, (R₁)₂N+O—, NHCOR₁, CO₂H, CO₂R₁, CN, CONH₂, CONHR or CON(R₁)₂ group, in which groups R₁ is selected from alkyl, aryl, aralkyl, alkylaryl, alkene or organosilyl groups which are optionally perfluorinated and optionally substituted by one or more carboxyl, epoxy, hydroxyl, alkoxy, amino, halogen or sulphonic groups,
Y and Y′, which are identical or different, are such that either Y or Y′, or both, comprise at least one phosphorus-based —P(O)(OR₂)(OR₃) function, R₂ and R₃, which are identical or different, representing a hydrogen atom or an alkyl, optionally haloalkyl, radical.

4. The polyphosphorus-based polymer bearing a chain-end thiol function according to claim 3, wherein in Formula I, R is a cyanomethyl group of formula CNCH₂—, 1-phenylethyl of formula CH₃(C₆H₅)CH—, or methylpropionyl of formula CH₃(CO₂CH₃)CH—.

5. The polyphosphorus-based polymer bearing a chain-end thiol function according to claim 3, wherein the molar fraction of monomer units of the polyphosphorus-based polymer comprising X and X′ ranges from 0 to 0.5.

6. The polyphosphorus-based polymer bearing a chain-end thiol function according to claim 1, wherein the polyphosphorus-based polymer bearing a chain-end thiol function has a number of units at least equal to 2 and at most equal to 1000.

7. The polyphosphorus-based polymer bearing a chain-end thiol function according to claim 1, wherein the polymer chain is a random copolymer of one or more monomers bearing at least one phosphonate and/or phosphonic function with one another or with one or more comonomers.

8. The polyphosphorus-based polymer bearing a chain-end thiol function according to claim 1, wherein the polymer chain is a block copolymer of one or more monomers bearing at least one phosphonate and/or phosphonic function with one another or with one or more comonomers.

9. A Method for synthesizing a polyphosphorus-based polymer bearing a chain-end thiol function, wherein the polyphosphorus-based polymer comprises on the one hand the homopolymerization of a monomer bearing at least one phosphonate and/or phosphonic function, or the copolymerization of one or more monomers bearing at least one phosphonate and/or phosphonic function with one another or with one or more comonomers, and, on the other hand, concomitantly or in succession, the chain-end functionalization of such a polymer by a thiol function.

10. The method according to claim 9, wherein the polyphosphorus-based polymer comprises the controlled radical polymerization of at least one monomer bearing at least one phosphonate and/or phosphonic function in the presence of a source of free radicals and a thiocarbonylthio chain transfer agent of general formula (II):
R—S(C═S)—Z (II)
in which:
R represents:
(i) an alkyl, acyl, aryl, alkenyl or alkynyl group,
(ii) a saturated or unsaturated, optionally aromatic carbon-based ring,
(iii) a saturated or unsaturated, optionally aromatic heterocycle, or these groups and rings (i), (ii) and (iii) possibly being substituted by substituted phenyl groups, substituted aromatic groups or alkoxycarbonyl or aryloxycarbonyl (—COOR′), carboxyl (—COOH), acyloxy (—O₂CR′), carbamoyl (—CONR′₂), cyano (—CN), alkylcarbonyl, alkylarylcarbonyl, arylcarbonyl, arylalkylcarbonyl, phthalimido, maleimido, succinimido, amidino, guanidino, hydroxyl (—OH), amino (—NR′₂), halogen, allyl, epoxy, alkoxy (—OR′), S-alkyl or S-aryl groups, groups having a hydrophilic or ionic character such as the alkali metal salts of carboxylic acids, the alkali metal salts of sulphonic acid, polyalkylene oxide chains (PEO, PPO) or cationic substituents (quaternary ammonium salts), R′ representing an alkyl or aryl group,
(iv) a polymer chain,
Z is an oxygen atom, a carbon atom, a sulphur atom, a nitrogen atom or a phosphorus atom, these atoms being substituted by one, two or three hydrocarbon-based radicals R″ so as to have the appropriate valency, possibly comprising at least one heteroatom, such that R″ represents a group as defined above for R:
and, after polymerization, a chemical modification of the thiocarbonylthio-terminated polymer into a thiol-terminated polymer.

11. The method according to claim 10, wherein the chemical modification is carried out by aminolysis reaction or by thermolysis reaction of the thiocarbonylthio groups.

12. The method according to claim 9, wherein the monomer bearing at least one phosphonate and/or phosphonic function is vinylphosphonic acid, vinylphosphonic acid dimethyl ester, vinylphosphonic acid bis(2-chloroethyl) ester, vinylidenediphosphonic acid, vinylidenediphosphonic acid tetraisopropyl ester, alpha-styrenephosphonic acid, dimethyl-p-vinylbenzylphosphonate, diethyl-P-vinylbenzylphosphonate, dimethyl(methacryloyloxy)methyl phosphonate, diethyl(methacryloyloxy)methyl phosphonate, diethyl 2-(acrylamido)ethylphosphonate, any unsaturated styrene, acrylate or methacrylate, acrylamido or methacrylamido, vinyl or allyl monomer bearing at least one dialkylphosphonate, phosphonic diacid or hemiacid —P(OH)(OR) group, or a mixture of these monomers.

13. The method according to claim 9, wherein the comonomer is a hydrophilic monomer (h) or a hydrophobic monomer (H),
the hydrophilic monomer (h) being
vinyl alcohol resulting from the hydrolysis of vinyl acetate,
a neutral acrylamido monomer,
a cyclic amide of vinylamine,
an ethylenic unsaturated mono- and dicarboxylic acid,
an ethylenic monomer comprising a sulphonic acid group or one of the alkali metal or ammonium salts thereof, or
a monomer selected from aminoalkyl (meth)acrylates, aminoalkyl (meth)acrylamides, monomers comprising at least one secondary, tertiary or quaternary amine function, diallyl dialkyl ammonium salts such as dimethylaminoethyl (meth)acrylate, dimethylaminopropyl (meth)acrylate, dimethylaminopropyl (meth)acrylamide, 2-vinylpyridine, 4-vinylpyridine and diallyldimethyl ammonium chloride,
the hydrophobic monomer (H) being
a styrene monomer,
an ester of acrylic acid or of methacrylic acid with optionally fluorinated C₁-C₁₂,
a vinyl nitrile containing from 3 to 12 carbon atoms,
a vinyl ester of a carboxylic acid,
a vinyl or vinylidene halide, or
a diene monomer.

14. The polyphosphorus-based polymer bearing a chain-end thiol function according to claim 3, wherein n and m are each greater than 2 and each less than 500.

15. The polyphosphorus-based polymer bearing a chain-end thiol function according to claim 5, wherein the molar fraction of monomer units of the polyphosphorus-based polymer comprising X and X′ ranges from 0 to 0.25.

16. The polyphosphorus-based polymer bearing a chain-end thiol function according to claim 5, wherein the molar fraction of monomer units of the polyphosphorus-based polymer comprising X and X′ is between 0 and 0.1.

17. The method according to claim 13, wherein the ester of acrylic acid or of methacrylic acid includes fluorinated C₁-C₈, alcohols.
